(19) United States
(12) Patent Application Publication
(10) Pub. No.: US 2026/0127190 A1
(43) Pub. Date: May 7, 2026

(54) DATA QUERY METHOD AND APPARATUS

(71) Applicant: BEIJING OCEANBASE TECHNOLOGY CO., LTD., Beijing (CN)

(72) Inventors: Zhuoran ZHANG, Hangzhou (CN); Zhenjiang XIE, Hangzhou (CN)

(21) Appl. No.: 19/435,498

(22) Filed: Dec. 29, 2025

Related U.S. Application Data
(63) Continuation of application No. PCT/CN2024/125752, filed on Oct. 18, 2024.

(30) Foreign Application Priority Data
Nov. 22, 2023 (CN) 202311570005.3

(51) Int. Cl. G06F 16/248; G06F 16/22

(52) U.S. Cl. CPC G06F 16/248; G06F 16/221

(57) ABSTRACT

One or more implementations of this specification provide a data query method and apparatus, including: performing range filtering on pre-constructed index data based on a query condition in a data query instruction and row-stored data in the index data to obtain a first data range; filtering the first data range based on another query condition and column-stored data in the index data to obtain a second data range; and processing data in the second data range based on the data query instruction to obtain a data query result. In the implementations of this specification, row-stored data and column-stored data are pre-constructed, so that in a data query operation, the row-stored data and the column-stored data can be invoked simultaneously, and a data intersection is calculated by using the row-stored data and the column-stored data, to quickly select a queried data range, thereby improving data query efficiency of a database.

### TECHNICAL FIELD

One or more implementations of this specification relate to the field of database technologies, and in particular, to a data query method and apparatus.

### BACKGROUND

With development of technologies, data amounts of various types of data increase explosively, and a database can provide services such as data storage and query. In a related technology, as an amount of business data continuously increase, an amount of index data created to query the business data increases accordingly.

### SUMMARY

One or more implementations of this specification provide a data query method and apparatus, a database system, and a storage medium.

According to a first aspect of one or more implementations of this specification, a data query method is provided, including: obtaining a data query instruction, where the data query instruction includes a plurality of query conditions; performing range filtering on pre-constructed index data based on at least one query condition in the plurality of query conditions and row-stored data in the index data to obtain a first data range; filtering the first data range based on another query condition in the plurality of query conditions and column-stored data in the index data to obtain a second data range; and processing data in the second data range based on the data query instruction to obtain a data query result.

In one or more implementations of this specification, the performing range filtering on pre-constructed index data based on at least one query condition in the plurality of query conditions and row-stored data in the index data to obtain a first data range includes: determining, from the index data based on a query field corresponding to the at least one query condition and the row-stored data, a row offset that satisfies the query condition; and performing range filtering on the index data based on the row offset to obtain the first data range.

In one or more implementations of this specification, the filtering the first data range based on another query condition in the plurality of query conditions and column-stored data in the index data to obtain a second data range includes: determining, from the index data based on a query field corresponding to the another query condition and the column-stored data, a column data range that satisfies the query condition; and determining the second data range based on an intersection of the column data range and the first data range.

In one or more implementations of this specification, the processing data in the second data range based on the data query instruction to obtain a data query result includes: reading the data in the second data range based on the row-stored data in response to that a quantity of columns of the data in the second data range is greater than a preset threshold, and processing the data to obtain the data query result; and reading the data in the second data range based on the column-stored data in response to that column data of the data in the second data range is less than or equal to the preset threshold, and processing the data to obtain the data query result.

In one or more implementations of this specification, the performing range filtering on pre-constructed index data based on at least one query condition in the plurality of query conditions and row-stored data in the index data to obtain a first data range includes: determining target index data from a plurality of pieces of pre-constructed index data based on a query field corresponding to the at least one query condition; and performing range filtering on the target index data based on the at least one query condition and the target index data to obtain the first data range.

In one or more implementations of this specification, a process of pre-constructing the index data includes: generating a preset index table based on to-be-stored data; writing the to-be-stored data into a memory based on the preset index table; respectively generating row-stored data and column-stored data in each column based on data in the memory in response to that an amount of data written into the memory reaches a preset capacity; and constructing the index data based on the row-stored data and the column-stored data.

In one or more implementations of this specification, a process of pre-constructing the index data includes: generating a plurality of preset index tables based on a query field in to-be-stored data; and for each preset index table, constructing corresponding index data based on the preset index table.

According to a second aspect of one or more implementations of this specification, a data query apparatus is provided, including: an instruction acquisition module, configured to obtain a data query instruction, where the data query instruction includes a plurality of query conditions; a first filtering module, configured to perform range filtering on pre-constructed index data based on at least one query condition in the plurality of query conditions and row-stored data in the index data to obtain a first data range; a second filtering module, configured to filter the first data range based on another query condition in the plurality of query conditions and column-stored data in the index data to obtain a second data range; and a query result module, configured to process data in the second data range based on the data query instruction to obtain a data query result.

In one or more implementations of this specification, the first filtering module is configured to: determine, from the index data based on a query field corresponding to the at least one query condition and the row-stored data, a row offset that satisfies the query condition; and perform range filtering on the index data based on the row offset to obtain the first data range.

In one or more implementations of this specification, the second filtering module is configured to: determine, from the index data based on a query field corresponding to the another query condition and the column-stored data, a column data range that satisfies the query condition; and determine the second data range based on an intersection of the column data range and the first data range.

In one or more implementations of this specification, the query result module is configured to: read the data in the second data range based on the row-stored data in response to that a quantity of columns of the data in the second data range is greater than a preset threshold, and process the data to obtain the data query result; and read the data in the second data range based on the column-stored data in response to that column data of the data in the second data range is less than or equal to the preset threshold, and process the data to obtain the data query result.

In one or more implementations of this specification, the first filtering module is configured to: determine target index data from a plurality of pieces of pre-constructed index data based on a query field corresponding to the at least one query condition; and perform range filtering on the target index data based on the at least one query condition and the target index data to obtain the first data range.

In one or more implementations of this specification, the apparatus further includes an index construction module. The index construction module is configured to: generate a preset index table based on to-be-stored data; write the to-be-stored data into a memory based on the preset index table; respectively generate row-stored data and column-stored data in each column based on data in the memory in response to that an amount of data written into the memory reaches a preset capacity; and construct the index data based on the row-stored data and the column-stored data.

In one or more implementations of this specification, the index construction module is configured to: generate a plurality of preset index tables based on a query field in to-be-stored data; and for each preset index table, construct corresponding index data based on the preset index table.

According to a third aspect of one or more implementations of this specification, a database system is provided, including: a processor; and a storage storing a computer instruction. The computer instruction is used to enable the processor to perform the method according to any one of the implementations of the first aspect.

According to a fourth aspect of one or more implementations of this specification, a storage medium is provided and stores a computer instruction. The computer instruction is used to enable a computer to perform the method according to any one of the implementations of the first aspect.

The data query method in the implementations of this specification includes: performing range filtering on pre-constructed index data based on a query condition in a data query instruction and row-stored data in the index data to obtain a first data range; filtering the first data range based on another query condition and column-stored data in the index data to obtain a second data range; and processing data in the second data range based on the data query instruction to obtain a data query result. In the implementations of this specification, index data including both row-stored data and column-stored data is pre-constructed, so that in a data query operation, the row-stored data and the column-stored data can be invoked simultaneously, and a data intersection is calculated by using the row-stored data and the column-stored data, to quickly select a queried data range, thereby improving data query efficiency of a database.

### BRIEF DESCRIPTION OF DRAWINGS

FIG. 1 is a flowchart of a data query method according to an example implementation of this specification;

FIG. 2 is a diagram of a principle of a data query method according to an example implementation of this specification;

FIG. 3 is a diagram of a principle of a data query method according to an example implementation of this specification;

FIG. 4 is a flowchart of a data query method according to an example implementation of this specification;

FIG. 5 is a flowchart of a data query method according to an example implementation of this specification;

FIG. 6 is a flowchart of a data query method according to an example implementation of this specification;

FIG. 7 is a diagram of a principle of a data query method according to an example implementation of this specification;

FIG. 8 is a flowchart of a data query method according to an example implementation of this specification;

FIG. 9 is a block diagram of a structure of a data query apparatus according to an example implementation of this specification; and

FIG. 10 is a block diagram of a structure of a database system according to an example implementation of this specification.

### DESCRIPTION OF EMBODIMENTS

Example implementations are described in detail herein, and examples of the example implementations are presented in the accompanying drawings. When the following description relates to the accompanying drawings, unless otherwise indicated, same numbers in different accompanying drawings represent same or similar elements. Implementations described in the following example implementations do not represent all implementations consistent with one or more implementations of this specification. On the contrary, the implementations are merely examples of apparatuses and methods that are described in the appended claims in detail and consistent with some aspects of one or more implementations of this specification.

It should be noted that, in other implementations, the steps of the corresponding method are not necessarily performed in the order shown and described in this specification. In some other implementations, the method can include more or fewer steps than those described in this specification. In addition, a single step described in this specification may be decomposed into a plurality of steps in other implementations for description; and a plurality of steps described in this specification may be combined into a single step for description in other implementations.

In addition, user information (including but not limited to user device information, user personal information, etc.) and data (including but not limited to data used for analysis, stored data, displayed data, etc.), if any, used in this specification are information and data that are authorized by a user or are fully authorized by each party, related data needs to be collected, used, and processed by abiding by related laws and regulations and standards of a related country and region, and a corresponding operation entry is provided, so that the user chooses to perform authorization or rejection.

With development of technologies, data amounts of various types of data increase explosively, and a database can provide services such as data storage and query. In a related technology, a storage structure of a database can include row-based storage and column-based storage.

The row-based storage means that data is stored in basic units of rows, and each row includes values of all fields in a table. Because all fields of each row of data are stored together, the row-based storage has a better online transaction processing (OLTP) capability, and satisfies requirements for concurrency and consistency in processing of data in a database.

The column-based storage means that data is stored in basic units of columns, and data in a same column is stored together to facilitate data aggregation and compression. Therefore, compared with the row-based storage, the column-based storage greatly facilitates an operation of performing column-based query and selection, and improves online analysis processing (OLAP) performance of a database.

A database index is a data structure that can increase a speed of querying data in a database table, and the index is used to quickly position data without searching each row in the database table each time the table is accessed. In a related technology, in addition to applying a column-based storage structure to a data table, some databases can also apply the column-based storage structure to an index to construct a column-based storage index, thereby improving performance of column-based query of a database, and accelerating an OLAP operation of the database. However, as a data amount continuously increases, query performance of a database is affected by both a row-based storage index and a column-based storage index, leading to reduction in data query efficiency.

One or more implementations of this specification provide a data query method and apparatus, a database system, and a storage medium, which respectively construct row-stored data and column-stored data in a same index file, and quickly select data by using redundant data stored in rows and columns, thereby improving data query efficiency of a database.

According to the data query method in the implementations of this specification, index data including a row-based storage index and a column-based storage index can be pre-constructed, so that during data query, the pre-constructed row-based storage index and column-based storage index can be invoked simultaneously, to quickly select queried data. For ease of understanding and description, the following first describes a process of constructing index data, and then describes a data query process.

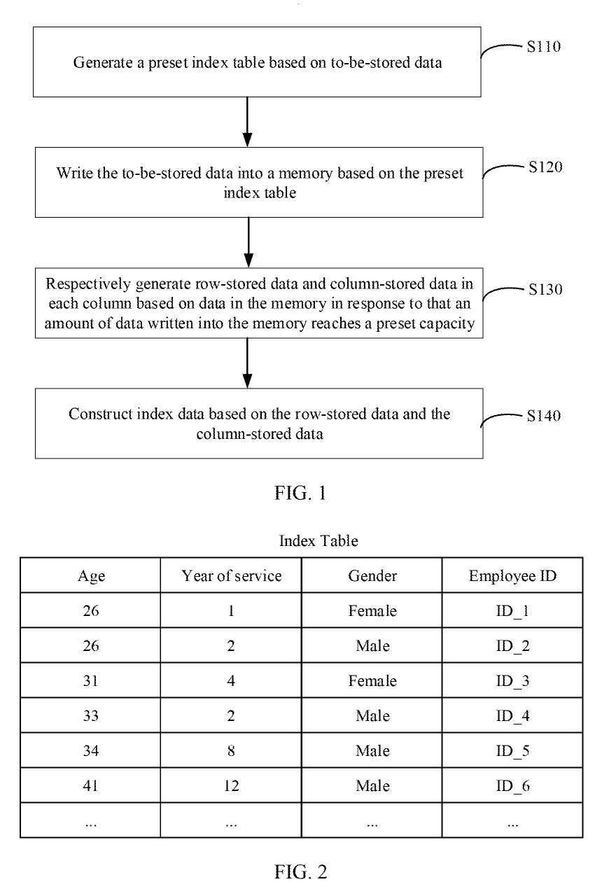

As shown in FIG. 1, in some implementations, a process of pre-constructing index data in an example data query method in this specification includes steps S110 to S140.

S110: Generate a preset index table based on to-be-stored data.

In the implementations of this specification, the to-be-stored data is data that needs to be written into a disk for permanent storage, and the preset index table is an index table generated by ordering the to-be-stored data based on one or more fields.

An index table includes one or more fields used to query data, and each row of data in the index table includes values corresponding to these fields. In addition, the index table further includes a primary key of each row of data, the primary key is one or more fields in the table, and a value of the primary key is used to uniquely identify a location of a row of data in a primary table. For example, an index table shown in FIG. 2 includes four columns of data in total, and fields corresponding to the columns of data are respectively "age", "year of service", "gender", and "employee ID", where the "employee ID" field represents a primary key of the index table.

It should be noted that the preset index table can include indexes constructed based on one or more fields. For example, in FIG. 2, the index table can be composite indexes constructed based on the "age", "year of service", and "gender" fields. For example, the preset index table is sorted based on the "age" field; in a case of a same age, the preset index table is sorted based on the "year of service" fields; and in a case of a same year of service, the preset index table is sorted based on the "gender" field. This can be understood by a person skilled in the art, and details are not described in this specification.

S120: Write the to-be-stored data into a memory based on the preset index table.

In some implementations of this specification, a log-structured merge-tree (LSM Tree) can be used as a basic data storage structure. Certainly, a person skilled in the art can understand that, a data structure is not limited to a form of the LSM Tree, and can alternatively be a data structure such as a B Tree or a B+ Tree. The LSM Tree is used as an example for description in the implementations of this specification.

The LSM Tree is a data structure that spans a memory and a disk, and includes a C0 Tree (e.g., a MemTable) in the memory and a plurality of subtrees in the disk, such as a C1 Tree, a C2 Tree, ..., and a Cn Tree. The LSM Tree writes write operations such as insertion, modification, and deletion into the Memtable in the memory in by appending a write and performs pre-sorting. After an amount of data in the MemTable reaches a threshold, the data is written into the disk in sequence for persistent storage, and a data structure used after flushing is an SSTable. Further, to improve read performance, the LSM Tree needs to periodically merge SSTable files in the disk. During the merging, write appending operations for same data are merged to reduce a data amount.

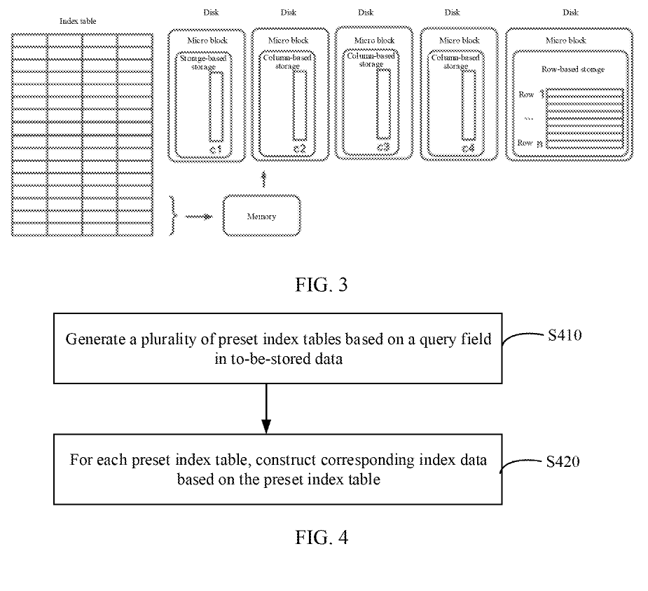

In implementations of this specification, with reference to FIG. 3, for data in the preset index table, e.g., the to-be-stored data described in this specification, when index data is constructed, the data in the table can be written into the MemTable in the memory in sequence.

S130: Respectively generate row-stored data and column-stored data in each column based on data in the memory in response to that an amount of data written into the memory reaches a threshold capacity.

With reference to the above-mentioned description, it can be learned that when an amount of data written into the MemTable in the memory reaches a threshold, the data in the memory will be flushed into the SSTable in the disk. For example, a capacity threshold can be set for a capacity of the MemTable in the memory. When an amount of data written into the MemTable in the memory reaches the capacity threshold, it indicates that the data in the MemTable in the memory needs to be written into the SSTable in the disk.

In implementations of this specification, when the data in the Memtable in the memory is written into the SSTable in the disk, not only the data will be written based on row-based storage to form row-stored data, but also each column of data will be written based on column-based storage to construct column-stored data. In other words, the SSTable written into the disk includes not only the row-stored data but also the column-stored data of each column of data.

Using an OceanBase database as an example, the database divides a disk into macro blocks of a fixed size, and internal data in the macro blocks is organized into a plurality of micro blocks. With reference to FIG. 3, when the data is flushed from the MemTable in the memory into the SSTable in the disk, row-stored data and column-stored data need to be generated in a same SSTable index file based on a row-based storage format and a column-based storage format. The row-stored data in the SSTable is data in a row 1 to in a row n in the figure, and the column-stored data is data in C1 to C4 in the figure.

S140: Construct the index data based on the row-stored data and the column-stored data.

In implementations of this specification, after the row-stored data and the column-stored data are obtained by using the above-mentioned process, the row-stored data and the column-stored data form the index data used for data query.

It should be noted that, in implementations of this specification, compared with a related row-based storage index, a column-based storage index of each column of data is redundantly constructed in addition to a row-based storage index, and selection of queried data can be accelerated based on both the row-based storage index and the column-based storage index. A data query process is described in the following description of this specification.

In addition, in a related technology, using an SQL server database as an example, during data query, an optimizer selects index data most related to a queried column. When invoking index data to perform a query operation, the database can invoke only one index at the same time. However, in the implementations of this specification, the row-stored data and the column-stored data are constructed in the same index data. Even if the optimizer can invoke only one index when the database queries data, the row-stored data and the column-stored data in the index data can be invoked simultaneously to implement the data query process in the following description of this specification.

In addition, it can be understood that the column-stored data is usually data obtained after the column of data is compressed, which is not conducive to in-situ updating based on a storage structure such as a B Tree and a B+ Tree, resulting in a relatively weak OLTP capability of the database. However, in some implementations of this specification, data is stored by appending a write by using the LSM Tree, and the SSTable does not need to be updated in situ. Therefore, the OLTP capability of the database is not affected, so that the database improves the OLAP capability by using the column-based storage index on the basis of reserving an original OLTP capability.

In implementations, e.g., those shown in FIG. 1, a process of constructing index data based on a preset index table is described. Actually, for a same data table, different preset index tables can be generated based on different query fields, so that corresponding index data is constructed based on each preset index table according to the above-mentioned method process, which is described below with reference to FIG. 4.

As shown in FIG. 4, in some implementations, a process of constructing index data in an example data query method in this specification includes steps S410 to S420.

S410: Generate a plurality of preset index tables based on a query field in to-be-stored data.

S420: For each preset index table, construct corresponding index data based on the preset index table.

With reference to the above-mentioned description, it can be learned that the to-be-stored data refers to data that is to be written into a disk for permanent storage, for example, a data table of the to-be-stored data is FIG. 2.

It can be understood that the data table of the to-be-stored data includes a plurality of fields, for example, "age", "year of service", "gender", and "employee ID". The preset index table can be a data table obtained by sorting data based on one or more fields. For example, as shown in FIG. 2, an index table related to the "age" field can be obtained through sorting in ascending order based on the "age" field.

Similarly, the data can also be sorted based on any field such as "year of service" or "gender", and can be sorted based on a value of a next field when values of the field are the same. For example, the data table shown in FIG. 2 can be sorted in ascending order based on the "age" field, and data whose age fields have a same value can be further sorted in ascending order based on a value of the "year of service" field, and so on.

Similarly, the data table of the to-be-stored data can be processed based on different query fields to obtain a plurality of corresponding preset index tables. For each preset index table, corresponding index data can be constructed according to the above-mentioned method process shown in FIG. 1.

In implementations of this specification, a plurality of pieces of index data can be obtained based on a plurality of preset index tables, and at least one piece of index data can be used as a clustered storage index, and remaining index data can be used as a non-clustered storage index. The clustered storage index and the non-clustered storage index have a same function, and differ in that the clustered storage index is a primary storage index of the entire data table, and the non-clustered storage index is an auxiliary index created for the data table.

In a related technology, using an SQL server database as an example, due to other constraint conditions for a column-based storage index of the SQL server, a maximum of one non-clustered column-based storage index is allowed to be created. However, in implementations of this specification, a quantity of non-clustered storage indexes is not limited, and a plurality of non-clustered column-based storage indexes can be respectively constructed based on a plurality of preset index tables, to provide better support for an OLTP task.

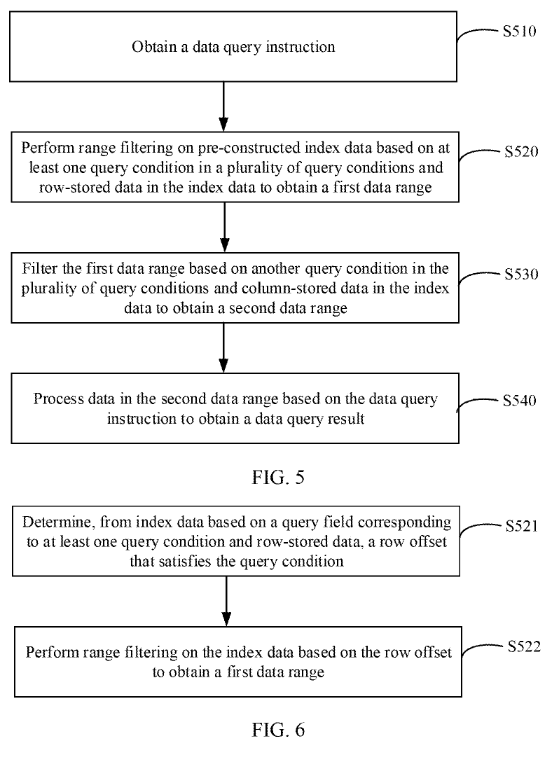

After an index data SSTable including the row-stored data and the column-stored data is constructed by using the above-mentioned process, data query can be performed based on the index data SSTable, which is described below with reference to FIG. 5.

As shown in FIG. 5, in some implementations, an example data query method in this specification includes steps S510 to S540.

S510: Obtain a data query instruction.

In implementations of this specification, the data query instruction refers to a query statement used to query required data in a database. The data query instruction usually includes one or more query conditions. The database needs to select, based on these query conditions, data that satisfies the query conditions and return a query result.

In some implementations, the data query instruction can be represented as a structured query language (SQL) command, such as a Select command. Certainly, the data query instruction is not limited thereto. For example, in some implementations, the data query instruction can also be implemented by using another operating language of a relational database, an operating language of a non-relational database, or another feasible computer language or information transmission format. For example, the data query instruction can also be represented as a hypertext transfer protocol (http) request, such as a data request using a Get method.

In addition, the one or more query conditions carried in the data query instruction can also be in a plurality of representation forms, and the representation form of the query condition varies based on the data query instruction. For example, an example basic SQL query instruction can be represented as "SELECT ID, Name FROM Student WHERE ID=5", which is used to query a number and a name of a student whose ID is 5 in a data table Student. Therefore, a query condition in the query instruction can include two parts, where one part is "ID" and "Name" that appear after the SELECT identifier, and is used to indicate an attribute of found data; and the other part is "ID=5" that appears after the WHERE identifier, and is used to indicate a condition that the data needs to satisfy.

It can be learned from the above-mentioned description that, in implementations of this specification, the data query instruction can include more than one query condition, the query condition is also not limited to a numerical relational expression, and an obtained data record should satisfy all query conditions in the query instruction.

Certainly, the above-mentioned description is only an example. A form of the query condition is not limited in the implementations of this specification. For example, in some implementations of this specification, a target data record can be positioned based on a row address and/or a column address, so that the query condition corresponding to the query instruction can be related information of the row address and/or the column address.

S520: Perform range filtering on pre-constructed index data based on at least one query condition in the plurality of query conditions and row-stored data in the index data to obtain a first data range.

In the implementations of this specification, when the data query instruction includes a plurality of query conditions, preliminary range filtering can be first performed on the entire index data based on one or more query conditions in the data query instruction by using the row-stored data in the above-mentioned constructed index data, to select a data row that satisfies the query condition.

For example, an example query instruction is represented as "query all male employees aged over 40 in the table", which includes query conditions "age is greater than 40" and "gender is male", and data in a query result needs to satisfy all the query conditions.

In this scenario, first, based on a query field "age" corresponding to the query condition "age is greater than 40", a row offset of a data row whose value is greater than 40 in the "age" field in an index data table can be quickly selected by using the row-stored data, and then all data rows whose "age" fields having values less than or equal to 40 are filtered out based on the row offset, to complete primary row filtering on a data range to obtain the first data range. In other words, values of age fields of all data in the first data range are greater than 40.

A process of filtering a data range based on the row-stored data to obtain the first data range continues to be described in the following implementation of this specification.

S530: Filter the first data range based on another query condition in the plurality of query conditions and column-stored data in the index data to obtain a second data range.

It can be understood that, data row filtering can be performed on a data table based on the row-stored data in S520. Then, for the first data range obtained after row filtering, a data range can be further quickly selected with reference to the column-stored data in the above-mentioned constructed index data.

In some implementations, for another query condition in the data query instruction, column-stored data that is to be invoked can be determined based on a field corresponding to the query condition, and then data column filtering can be performed on the first data range based on an intersection of the column-stored data and the first data range to obtain the second data range.

Still using the above-mentioned scenario as an example, after the first data range is obtained by performing data row filtering based on the query condition "age is greater than 40" and the row-stored data, a field corresponding to the query condition "gender is male" can be determined as "gender" based on the query condition, and then the column-stored data is invoked to obtain a column data range whose field is "sex". It can be understood that, because the column data range includes gender data in the entire data table, the column data range needs to be intersected with the first data range, and data in the obtained second data range is gender data of all employees aged over 40.

S540: Process data in the second data range based on the data query instruction to obtain a data query result.

In implementations of this specification, after the second data range is obtained through the above-mentioned data row filtering process and data column process, the data in the second data range can be read, and corresponding processing is performed on the data to obtain a final data query result.

A data processing manner is to be determined based on a query condition in the data query instruction. For example, in the above-mentioned example, an example data query condition is represented as "male employees aged over 40". In this case, data whose value is "male" can be further selected from gender data in the second data range, and a data query result is returned. The data query result includes data information of all male employees aged over 40.

In another example, an example data query condition indicates "a total quantity of male employees aged over 40". In this case, after the data whose value is "male" is selected from the gender data in the second data range, aggregation processing is further performed on the selected data to obtain a total amount of data through calculation, and a data query result is returned. The data query result includes a quantity of all male employees aged over 40.

Certainly, a person skilled in the art can understand that, a manner of processing the data in the second data range is not limited to the above-mentioned examples. Other manners of processing the data in the second data range are also possible and included in the scope of the specification. Further details on such manners of processing are not needed for the appreciation of implementations of the specification.

In some implementations of this specification, when the data in the second data range is read, a quantity of columns of the data in the second data range can be determined. When the quantity of columns of the data in the second data range is very large, if data is read based on the column-stored data, a large quantity of decompression operations will be performed, and IO overheads for data query exceed those for data query based on the row-stored data. On the contrary, when the quantity of columns of the data in the second data range is relatively small, if data is read based on the row-stored data, a large quantity of redundant data in each row of data will be read, and IO overheads for data query far exceed those for data query based on the column-stored data.

Therefore, in some implementations of this specification, a corresponding threshold can be set for the quantity of columns in the second data range. In a data query phase, after the second data range is determined, the quantity of columns included in the second data range can be compared with the threshold. If the quantity of columns included in the second data range is greater than the threshold, it indicates that there are many columns in the second data range that currently need to be queried. In this case, if data is read based on the column-stored data, IO overheads are very high, and therefore data that needs to read can be read based on the row-stored data. On the contrary, if the quantity of columns included in the second data range is less than or equal to the threshold, it indicates that there are few columns in the second data range that currently need to be queried. In this case, if data is read based on the column-stored data, query efficiency is greatly improved, and IO overheads are reduced compared with those for the row-stored data. Therefore, data that needs to read can be read based on the column-stored data. This is described in the following implementation of this specification.

After the data in the second data range is read, the data can be processed based on a query condition in the data query instruction according to the above-mentioned data processing process, to obtain a corresponding data query result and return the data query result. This is not described in detail in this specification.

It can be learned from the above that, in implementations of this specification, index data including both row-stored data and column-stored data is pre-constructed, so that in a data query operation, the row-stored data and the column-stored data can be invoked simultaneously, and a data intersection is calculated by using the row-stored data and the column-stored data, to quickly select a queried data range, thereby improving data query efficiency of a database.

As shown in FIG. 6, in some implementations, a process of performing range filtering on the index data to obtain the first data range in an example data query method in this specification includes steps S521 to S522.

S521: Determine, from the index data based on a query field corresponding to the at least one query condition and the row-stored data, a row offset that satisfies the query condition.

S522: Perform range filtering on the index data based on the row offset to obtain the first data range.

In implementations of this specification, when a data query operation is performed, first, a data row that satisfies a query condition can be selected based on a query field corresponding to the query condition with reference to the row-stored data in the pre-constructed index data.

It should be noted that, with reference to the above-mentioned implementation, it can be learned that in the implementations of this specification, a plurality of preset index tables can be generated based on a plurality of query fields, and a plurality of pieces of index data can be constructed. Therefore, in the implementations of this specification, during data query, target index data can be first determined from the plurality of pieces of index data based on a query field corresponding to a query condition.

For example, an example data query instruction is represented as "query a quantity of male employees aged over 30 with more than 3 years of service in the table". Therefore, target index data sorted based on age can be determined from the plurality of pieces of index data based on a query field "age" corresponding to the query condition "age is greater than 30".

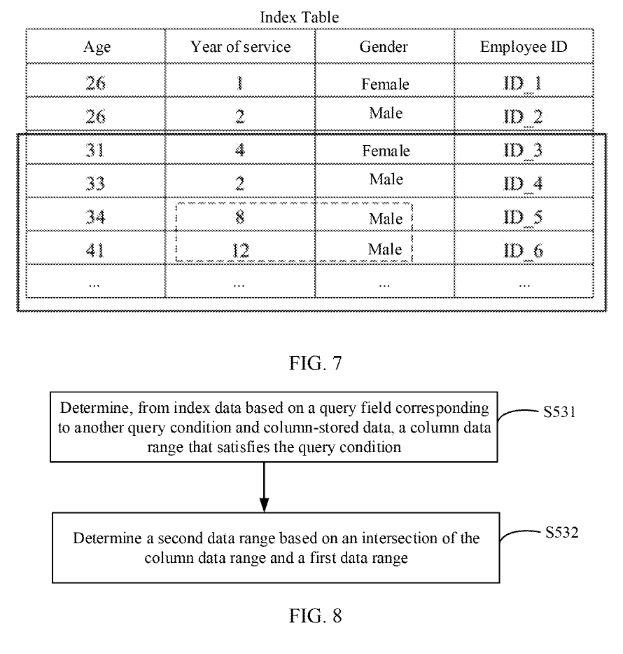

For example, a preset index table corresponding to the target index data can be shown in FIG. 7. The target index data includes four columns of data in total, and fields corresponding to the columns of data are respectively "age", "year of service", "gender", and "employee ID", where the "employee ID" field represents a primary key of the index table. In the example of FIG. 7, the index table is arranged in ascending order based on the age field, which is sorted based on the "year of service" field in a case of a same age, and is further sorted based on the "gender" field in a case of a same year of service.

In this example scenario, first, it can be determined, based on the query condition "age is greater 30", that a query field corresponding to the query condition is "age". Then, a row offset that satisfies "age is greater 30" is determined from the index data based on the row-stored data and the query condition, where the row offset indicates a location of a data row that satisfies the query condition. For example, as shown in the example in FIG. 7, a third row of data "age=31 year of service=2 gender=male" satisfies the query condition "age is greater than 30", and therefore a row offset is 3, which indicates that data in the third row and rows below the third row satisfies the query condition.

After the row offset is determined based on the row-stored data, range filtering is performed on the index data based on the row offset to obtain the filtered first data range. For example, in the example scenario shown in FIG. 7, a range of the first two rows of data is filtered based on the row offset to obtain a remaining first data ranges, e.g., the first data range represents the data in the third row and the rows after the third row in a solid line box in FIG. 7.

As shown in FIG. 8, in some implementations, a process of filtering the first data range to obtain the second data range in an example data query method in this specification includes steps S531 to S532.

S531: Determine, from the index data based on a query field corresponding to the another query condition and the column-stored data, a column data range that satisfies the query condition.

S532: Determine the second data range based on an intersection of the column data range and the first data range.

Still using the scenario shown in FIG. 7 as an example, the data query instruction further includes query conditions "year of service is greater than 3 years" and "gender is male", and query fields corresponding to the query conditions are respectively "year of service" and "gender". Therefore, two columns of data in the two fields "gender" and "year of service" can be obtained based on the query fields and the column-stored data.

For example, in the example shown in FIG. 7, the column data range obtained through filtering based on the column-stored data is a data range in a dashed-line box in the figure. Then, an intersection is calculated based on the column data range and the first data range to obtain the second data range. For example, in the example in FIG. 7, the intersection of the column data range in the dashed-line box and the first data range in the solid-line box is calculated to obtain the second data range, where the data in the second data range indicates data that satisfies all query conditions in the data query instruction.

After the second range data is determined, corresponding data needs to be read from the second range data. In some implementations of this specification, a process of reading the data in the second data range includes: reading the data in the second data range based on the row-stored data in response to that a quantity of columns of the data in the second data range is greater than a preset threshold; and reading the data in the second data range based on the column-stored data in response to that the quantity of columns of the data in the second data range is greater than the preset threshold.

It should be noted that, for ease of understanding and description, in the example in FIG. 7, only a scenario in which a small quantity of columns is shown. Actually, in a large data processing scenario, a quantity of columns in a data table is very large, and data stored based on column-based storage usually needs to be compressed. Therefore, in a data query phase, when data in many columns is read based on the column-stored data, a large quantity of data decompression operations are required, resulting in large IO overheads for data query, which even exceed overheads for reading corresponding column data based on the row-stored data.

Therefore, in some implementations of this specification, a corresponding preset threshold cam be preset for a quantity of columns in the second data range. The preset threshold represents a critical value for invoking the row-stored data and the column-stored data. A value of the preset threshold can be selected based on an application scenario. This is not limited in this specification.

In some implementations, the quantity of columns in the second data range can be compared with the preset threshold. If the quantity of columns is greater than the preset threshold, it indicates that a quantity of columns that currently need to be read is large. If data is read based on the column-stored data, query performance is not improved, and even high IO overheads may be generated. Therefore, the row-stored data can be invoked to read the data in the second data range.

If the quantity of columns is less than or equal to the preset threshold, it indicates that a quantity of columns that currently need to be read is not large. If data is read based on the column-stored data, data query efficiency is greatly improved, and IO overheads are reduced compared with those for the row-stored data. Therefore, the column-stored data can be invoked to read the data in the second data range.

After the data in the second data range is read, the data can be processed based on a query condition in the data query instruction according to the above-mentioned data processing process, to obtain a corresponding data query result and return the result. For example, in the above-mentioned example scenario in FIG. 7, after the data in a second data range is obtained through reading, aggregation processing can be performed on all read data to obtain a data query result indicating a total quantity of male employees aged over 30 with more than 3 years of service, and the data query result is returned.

It can be learned from the above-mentioned description that, in the implementations of this specification, during data query, the row-stored data and the column-stored data can be invoked simultaneously, and a data intersection is calculated by using the row-stored data and the column-stored data, to quickly select a queried data range, thereby improving data query efficiency of a database. In addition, when data is read, based on a quantity of columns of the read data, the row-stored data or the column-stored data is selected for reading the data, to reduce IO overheads and further improve data query efficiency and an OLAP capability of a database.

In addition, with reference to the above-mentioned, in this specification implementation, a quantity of non-clustered storage indexes is not limited, and multiple non-clustered column-based storage indexes may be separately constructed based on multiple preset index tables, so as to improve an OLTP capability of the database. In addition, in this specification implementation, data is stored by appending a write by using the LSM Tree, and an SSTable does not need to be updated in situ. Therefore, an OLTP capability of the database is not affected, so that the database improves an OLAP capability by using column-stored data on the basis of reserving an original OLTP capability.

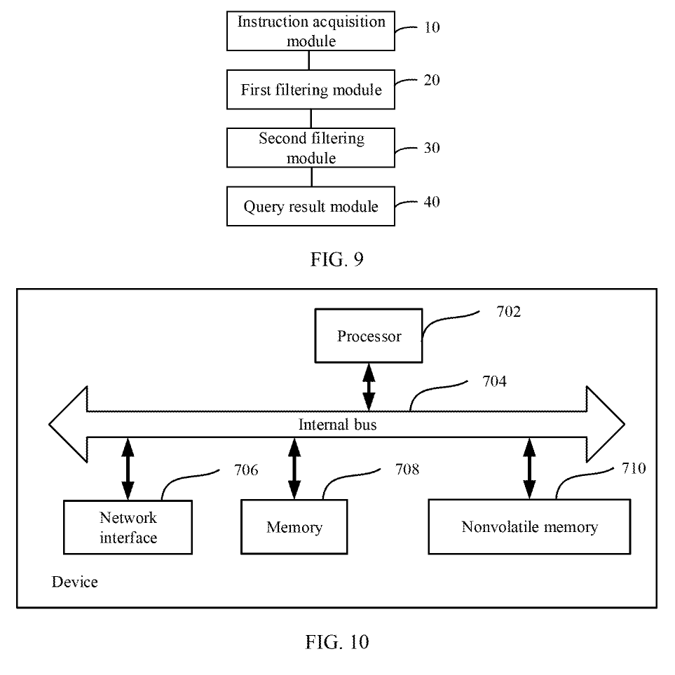

In some implementations, this specification provides a data query apparatus. As shown in FIG. 9, the data query apparatus includes: an instruction acquisition module 10, configured to obtain a data query instruction, where the data query instruction includes a plurality of query conditions; a first filtering module 20, configured to perform range filtering on pre-constructed index data based on at least one query condition in the plurality of query conditions and row-stored data in the index data to obtain a first data range; a second filtering module 30, configured to filter the first data range based on another query condition in the plurality of query conditions and column-stored data in the index data to obtain a second data range; and a query result module 40, configured to process data in the second data range based on the data query instruction to obtain a data query result.

It can be learned from the above-mentioned description that, in the implementations of this specification, row-stored data and column-stored data are pre-constructed, so that in a data query operation, the row-stored data and the column-stored data can be invoked simultaneously, and a data intersection is calculated by using the row-stored data and the column-stored data, to quickly select a queried data range, thereby improving data query efficiency of a database.

In one or more implementations of this specification, the first filtering module 20 is configured to: determine, from the index data based on a query field corresponding to the at least one query condition and the row-stored data, a row offset that satisfies the query condition; and perform range filtering on the index data based on the row offset to obtain the first data range.

In one or more implementations of this specification, the second filtering module 30 is configured to: determine, from the index data based on a query field corresponding to the another query condition and the column-stored data, a column data range that satisfies the query condition; and determine the second data range based on an intersection of the column data range and the first data range.

In one or more implementations of this specification, the query result module 40 is configured to: read the data in the second data range based on the row-stored data in response to that a quantity of columns of the data in the second data range is greater than a preset threshold, and process the data to obtain the data query result; and read the data in the second data range based on the column-stored data in response to that column data of the data in the second data range is less than or equal to the preset threshold, and process the data to obtain the data query result.

In one or more implementations of this specification, the first filtering module 20 is configured to: determine target index data from a plurality of pieces of pre-constructed index data based on a query field corresponding to the at least one query condition; and perform range filtering on the target index data based on the at least one query condition and the target index data to obtain the first data range.

In one or more implementations of this specification, the apparatus further includes an index construction module. The index construction module is configured to: generate a preset index table based on to-be-stored data; write the to-be-stored data into a memory based on the preset index table; respectively generate row-stored data and column-stored data in each column based on data in the memory in response to that an amount of data written into the memory reaches a preset capacity; and construct the index data based on the row-stored data and the column-stored data.

In one or more implementations of this specification, the index construction module is configured to: generate a plurality of preset index tables based on a query field in to-be-stored data; and for each preset index table, construct corresponding index data based on the preset index table.

It can be learned from the above-mentioned description that, in the implementations of this specification, during data query, the row-stored data and the column-stored data can be invoked simultaneously, and a data intersection is calculated by using the row-stored data and the column-stored data, to quickly select a queried data range, thereby improving data query efficiency of a database. In addition, when data is read, based on a quantity of columns of the read data, the row-stored data or the column-stored data is selected for reading the data, to reduce IO overheads and further improve data query efficiency and an OLAP capability of a database.

In addition, with reference to the above-mentioned, in this specification implementation, a quantity of non-clustered storage indexes is not limited, and multiple non-clustered column-based storage indexes may be separately constructed based on multiple preset index tables, so as to improve an OLTP capability of the database. In addition, in this specification implementation, data is stored by appending a write by using the LSM Tree, and an SSTable does not need to be updated in situ. Therefore, an OLTP capability of the database is not affected, so that the database improves an OLAP capability by using column-stored data on the basis of reserving an original OLTP capability.

In some implementations, this specification provides a database system, including: a processor; and a storage storing a computer instruction. The computer instruction is used to enable the processor to perform the method in any one of the above-mentioned implementations.

In some implementations, this specification provides a storage medium storing a computer instruction. The computer instruction is used to enable a computer to perform the method in any one of the above-mentioned implementations.

FIG. 10 is a schematic diagram of a structure of a database system according to an example embodiment. Referring to FIG. 10, in terms of hardware, the system includes a processor 702, an internal bus 704, a network interface 706, a memory 708, and a nonvolatile memory 710, and certainly, can further include other hardware needed by a scenario. One or more implementations of this specification can be implemented based on software. For example, the processor 702 reads a corresponding computer program from the nonvolatile memory 710 to the memory 708 and then runs the computer program. Certainly, in addition to software implementations, one or more implementations of this specification do not preclude other implementations, such as a logic device or a combination of software and hardware. In other words, an execution body of the following processing procedure is not limited to each logical unit, and can be hardware or a logic device.

The system, apparatus, module, or unit illustrated in the above-mentioned implementations can be implemented by using a computer chip or an entity, or can be implemented by using a product having a certain function. A typical implementation device is a computer, and an example form of the computer can be a personal computer, a laptop computer, a cellular phone, a camera phone, a smartphone, a personal digital assistant, a media player, a navigation device, an e-mail transceiver device, a game console, a tablet computer, a wearable device, or any combination of several devices in these devices.

In a typical configuration, the computer includes one or more processors (CPU), one or more input/output interfaces, one or more network interfaces, and one or more memories. The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The memory may include a non-persistent memory, a random access memory (RAM), a nonvolatile memory, and/or another form that are in a computer-readable medium, for example, a read-only memory (ROM) or a flash memory (flash RAM). The memory is an example of the computer-readable medium.

The computer-readable medium includes a persistent and a non-persistent, a removable and a non-removable medium, which can implement information storage by using any method or technology. Information can be a computer-readable instruction, a data structure, a program module, or other data. Examples of a storage medium of the computer include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, a magnetic disk storage, a quantum storage, a storage medium based on graphene, another magnetic storage device, or any other non-transmission medium. The storage medium can be configured to store information that can be accessed by a computing device. Based on the definition in this specification, the computer-readable medium does not include transitory media such as a modulated data signal and carrier.

It should be further noted that, the terms "include", "comprise", or any other variant thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by "includes a …" does not preclude the existence of additional identical elements in the process, method, product, or device that includes the element.

Example implementations of this specification are described above. Other implementations of the specification are possible and fall within the scope of the appended claims. In some cases, the actions or steps described in the claims can be performed in an order different from that in the implementations, and the desired results can still be achieved. In addition, processes described in the accompanying drawings do not necessarily need a specific order or a sequential order shown to achieve the desired results. In some implementations, multi-tasking and concurrent processing are feasible or may be advantageous.

Terms used in one or more implementations of this specification are merely used to describe example implementations, and are not intended to limit the one or more implementations of this specification. The terms "a" and "the" of singular forms used in one or more implementations of this specification and the appended claims are also intended to include plural forms, unless otherwise specified in the context clearly. It should be further understood that the term "and/or" used in this specification refers to and includes any or all possible combinations of one or more associated listed items.

It should be understood that although terms "first", "second", "third", etc. may be used in one or more implementations of this specification to describe various types of information, the information should not be limited to these terms. These terms are used merely to differentiate information of the same type. For example, without departing from the scope of one or more implementations of this specification, first information can also be referred to as second information, and similarly, the second information can also be referred to as the first information. Depending on the context, the word "if" used herein can be interpreted as "when …" or "while …" or "in response to determining …".

The above-mentioned descriptions are merely example implementations of one or more implementations of this specification, but are not intended to limit the one or more implementations of this specification. Any modification, equivalent replacement, improvement, etc. made without departing from the spirit and principle of the one or more implementations of this specification shall fall within the protection scope of the one or more implementations of this specification.

What is claimed is:

1. A data query method, comprising:
receiving a data query instruction, the data query instruction including a plurality of query conditions;
performing range filtering on index data based on a first query condition of the plurality of query conditions and a first one of row-stored data or column-stored data in the index data to obtain a first data range;
filtering the first data range based on a second query condition of the plurality of query conditions and a second one of the row-stored data or the column-stored data in the index data to obtain a second data range; and
processing data in the second data range based on the data query instruction to obtain a data query result.

2. The method according to claim 1, wherein the performing range filtering on the index data based on the first query condition of the plurality of query conditions and the first one of the row-stored data or the column-stored data in the index data to obtain the first data range comprises:
determining, from the index data based on a query field corresponding to the first query condition and the first one of the row-stored data or the column-stored data, a first offset in row or in column corresponding to the first one of the row-stored data or the column-stored data that satisfies the first query condition; and
performing range filtering on the index data based on the first offset to obtain the first data range.

3. The method according to claim 1, wherein the filtering the first data range based on the second query condition of the plurality of query conditions and the second one of the row-stored data or the column-stored data in the index data to obtain the second data range comprises:
determining, from the index data based on a query field corresponding to the second query condition and the second one of the row-stored data or the column-stored data, a third data range that satisfies the second query condition; and
determining the second data range based on an intersection of the third data range and the first data range.

4. The method according to claim 1, wherein the processing data in the second data range based on the data query instruction to obtain the data query result comprises:
reading the data in the second data range based on the first one of the row-stored data or the column-stored data in response to that a quantity of columns or rows of the data corresponding to the second one of the row-stored data or the column-stored data in the second data range meets a threshold, and processing the data to obtain the data query result; and
reading the data in the second data range based on the second one of the row-stored data or the column-stored data in response to that the quantity of the columns or the rows of the data corresponding to the second one of the row-stored data or the column-stored data in the second data range does not meet the threshold, and processing the data to obtain the data query result.

5. The method according to claim 1, wherein the performing range filtering on the index data based on the first query condition of the plurality of query conditions and the first one of the row-stored data or the column-stored data in the index data to obtain the first data range comprises:
determining target index data from a plurality of pieces of index data based on a query field corresponding to the first query condition; and
performing range filtering on the target index data based on the first query condition and the target index data to obtain the first data range.

6. The method according to claim 1, comprising:
generating an index table based on to-be-stored data;
writing the to-be-stored data into a data storage element based on the index table;
respectively generating the row-stored data and the column-stored data based on data in the data storage element in response to that an amount of data written into the data storage element reaches a capacity threshold; and
constructing the index data based on the row-stored data and the column-stored data generated.

7. The method according to claim 1, comprising:
generating a plurality of index tables based on a query field in to-be-stored data; and
for each index table of the plurality of index tables, constructing corresponding index data based on the index table.

8. A database system, comprising:
one or more processors; and
one or more storage elements, the one or more storage element, individually or collectively, storing computer instructions, the computer instructions, when executed by the one or more processors, enabling the one or more processors to, individually or collectively, perform acts including:
receiving a data query instruction, the data query instruction including a plurality of query conditions;
performing range filtering on index data based on a first query condition of the plurality of query conditions and a first one of row-stored data or column-stored data in the index data to obtain a first data range;
filtering the first data range based on a second query condition of the plurality of query conditions and a second one of the row-stored data or the column-stored data in the index data to obtain a second data range; and
processing data in the second data range based on the data query instruction to obtain a data query result.

9. The database system according to claim 8, wherein the performing range filtering on the index data based on the first query condition of the plurality of query conditions and the first one of the row-stored data or the column-stored data in the index data to obtain the first data range comprises:
determining, from the index data based on a query field corresponding to the first query condition and the first one of the row-stored data or the column-stored data, a first offset in row or in column corresponding to the first one of the row-stored data or the column-stored data that satisfies the first query condition; and
performing range filtering on the index data based on the first offset to obtain the first data range.

10. The database system according to claim 8, wherein the filtering the first data range based on the second query condition of the plurality of query conditions and the second one of the row-stored data or the column-stored data in the index data to obtain the second data range comprises:
determining, from the index data based on a query field corresponding to the second query condition and the second one of the row-stored data or the column-stored data, a third data range that satisfies the second query condition; and
determining the second data range based on an intersection of the third data range and the first data range.

11. The database system according to claim 8, wherein the processing data in the second data range based on the data query instruction to obtain the data query result comprises:
reading the data in the second data range based on the first one of the row-stored data or the column-stored data in response to that a quantity of columns or rows of the data corresponding to the second one of the row-stored data or the column-stored data in the second data range meets a threshold, and processing the data to obtain the data query result; and
reading the data in the second data range based on the second one of the row-stored data or the column-stored data in response to that the quantity of the columns or the rows of the data corresponding to the second one of the row-stored data or the column-stored data in the second data range does not meet the threshold, and processing the data to obtain the data query result.

12. The database system according to claim 8, wherein the performing range filtering on the index data based on the first query condition of the plurality of query conditions and the first one of the row-stored data or the column-stored data in the index data to obtain the first data range comprises:
determining target index data from a plurality of pieces of index data based on a query field corresponding to the first query condition; and
performing range filtering on the target index data based on the first query condition and the target index data to obtain the first data range.

13. The database system according to claim 8, wherein the acts include:
generating an index table based on to-be-stored data;
writing the to-be-stored data into a data storage element based on the index table;
respectively generating the row-stored data and the column-stored data based on data in the data storage element in response to that an amount of data written into the data storage element reaches a capacity threshold; and
constructing the index data based on the row-stored data and the column-stored data generated.

14. The database system according to claim 8, wherein the acts include:
generating a plurality of index tables based on a query field in to-be-stored data; and
for each index table of the plurality of index tables, constructing corresponding index data based on the index table.

15. A storage medium, having computer instructions stored therein, wherein the computer instructions, when executed by one or more processors, enable the one or more processors to, individually or collectively, implement acts comprising:
receiving a data query instruction, the data query instruction including a plurality of query conditions;
performing range filtering on index data based on a first query condition of the plurality of query conditions and a first one of row-stored data or column-stored data in the index data to obtain a first data range;
filtering the first data range based on a second query condition of the plurality of query conditions and a second one of the row-stored data or the column-stored data in the index data to obtain a second data range; and
processing data in the second data range based on the data query instruction to obtain a data query result.

16. The storage medium according to claim 15, wherein the performing range filtering on the index data based on the first query condition of the plurality of query conditions and the first one of the row-stored data or the column-stored data in the index data to obtain the first data range comprises:
determining, from the index data based on a query field corresponding to the first query condition and the first one of the row-stored data or the column-stored data, a first offset in row or in column corresponding to the first one of the row-stored data or the column-stored data that satisfies the first query condition; and
performing range filtering on the index data based on the first offset to obtain the first data range.

17. The storage medium according to claim 15, wherein the filtering the first data range based on the second query condition of the plurality of query conditions and the second one of the row-stored data or the column-stored data in the index data to obtain the second data range comprises:
determining, from the index data based on a query field corresponding to the second query condition and the second one of the row-stored data or the column-stored data, a third data range that satisfies the second query condition; and
determining the second data range based on an intersection of the third data range and the first data range.

18. The storage medium according to claim 15, wherein the processing data in the second data range based on the data query instruction to obtain the data query result comprises:
reading the data in the second data range based on the first one of the row-stored data or the column-stored data in response to that a quantity of columns or rows of the data corresponding to the second one of the row-stored data or the column-stored data in the second data range meets a threshold, and processing the data to obtain the data query result; and
reading the data in the second data range based on the second one of the row-stored data or the column-stored data in response to that the quantity of the columns or the rows of the data corresponding to the second one of the row-stored data or the column-stored data in the second data range does not meet the threshold, and processing the data to obtain the data query result.

19. The storage medium according to claim 15, wherein the performing range filtering on the index data based on the first query condition of the plurality of query conditions and the first one of the row-stored data or the column-stored data in the index data to obtain the first data range comprises:
determining target index data from a plurality of pieces of index data based on a query field corresponding to the first query condition; and
performing range filtering on the target index data based on the first query condition and the target index data to obtain the first data range.

20. The storage medium according to claim 15, wherein the acts comprise:
generating an index table based on to-be-stored data;
writing the to-be-stored data into a data storage element based on the index table;
respectively generating the row-stored data and the column-stored data based on data in the data storage element in response to that an amount of data written into the data storage element reaches a capacity threshold; and
constructing the index data based on the row-stored data and the column-stored data generated.
